(19) United States
(12) Patent Application Publication
(10) Pub. No.: US 2025/0285778 A1
(43) Pub. Date: Sep. 11, 2025

(54) IRRADIATION STATION FOR A RADIOISOTOPE PRODUCTION SYSTEM

(71) Applicant: COMECER S.P.A., Castel Bolognese (RA) (IT)

(72) Inventors: Alessandro Brunetti, Castel Bolognese (RA) (IT); Marco Testa, Castel Bolognese (RA) (IT)

(21) Appl. No.: 18/859,384

(22) PCT Filed: Apr. 24, 2023
(86) PCT No.: PCT/IB2023/054186

§ 371 Date: Oct. 23, 2024

(30) Foreign Application Priority Data
Apr. 28, 2022 (IT) 102022000008456

(51) Int. Cl. G21G 1/10

(52) U.S. Cl. CPC G21G 1/10

(57) ABSTRACT

An irradiation station for producing a radioisotope, having a cyclotron for emitting a proton beam against a solid target material placed in a container and a cooling system for cooling the container. The container has a wall for supporting the solid target material and a cavity, which borders the wall and has an opening transverse to the axis of the container. The cooling system has a connection head which is couplable to the opening for circulating a cooling fluid in the cavity and comprises a flow diverter, a tip protruding from a hole of the flow diverter and movable along the hole against the action of a spring in contact with the tip, and an electrical connector in contact with the spring. When the connection head is coupled to the opening the flow diverter enters the cavity coaxially with the container and the tip presses against the wall.

### CROSS-REFERENCE TO RELATED APPLICATIONS

This Patent Application claims priority from Italian Patent Application No. 102022000008456 filed on Apr. 28, 2022, the entire disclosure of which is incorporated herein by reference.

### TECHNICAL FIELD

The present invention relates to an irradiation station for a radioisotope production system.

In particular, the invention is advantageously, but not exclusively, applied to the production of a radioisotope utilizing a medium- or high-energy cyclotron, i.e. a cyclotron with energy equal to or above 18 MeV, starting from a solid precursor material, also known as solid target material, in the form of a thin layer electrodeposited on a suitable metal support, or of a foil positioned on the metal support, or of a capsule of compressed powder positioned on the metal support, to which the following description will explicitly refer without thereby losing generality.

### BACKGROUND

To date, various types of radioisotopes for pharmaceutical use (radiopharmaceuticals) are obtained following the irradiation by means of a beam of protons (proton bombardment) of a solid target material typically having a metal origin.

The production process of a radioisotope starting from a solid target material substantially provides for the following steps: positioning a portion of solid target material on a metal support; irradiating he solid target material on the support by means of proton beam; dissolving the irradiated solid target material for obtaining a solution in which the radioisotope produced by the proton irradiation is present; and purifying the aforementioned solution for separating the radioisotope from the target material which did not react and from impurities. The positioning of the solid target material on the metal support takes place according to modes that depend on the type and form of solid target material utilized. For example, the solid target material is in the form of a thin portion electrodeposited on the support, or of a metal foil or of a capsule of compressed powder.

The aforementioned steps are carried out in relative processing stations and therefore the support carrying the solid target material has to be arranged inside a container in order to be transported between various processing stations, for example from the electrodeposition station to the irradiation station and from the irradiation station to the dissolution station.

Radioisotope production systems are known which comprise a positioning station, an irradiation station, a dissolution station, a purification station and an automated transportation system for the transportation, between some of the aforementioned stations, of the container containing the support with the solid target material still to be irradiated or already irradiated. For such reason, such container is also known as shuttle.

The irradiation station comprises a cyclotron for emitting the proton beam against the solid target material and a fluid cooling system which is connected to the support for the relative cooling during the proton bombardment. Furthermore, supports are known designed to be placed directly in the dissolution station and capable of resisting to the agents which produce the solution with the radioisotope.

The main factors that affect the productivity (mCi/uAh) of a radioisotope production system are the parameters of the proton beam, geometry and materials of the solid target material container, the type and the geometry of the solid target material, and the degradation of the beam due to possible obstacles which the proton beam passes through before reaching the solid target material. The main parameters of the proton beam which have an impact on the productivity are beam current (uA), beam energy (MeV) and beam diameter (mm).

For example, the type and geometry of the solid target material being equal, the increase in the beam current allows increasing the productivity. other In words, other parameters being equal, the productivity is directly linked to the beam current. However, the beam current set on the cyclotron may not result in the desired productivity because of the variability of the multiple parameters affecting it.

Furthermore, the increase in the beam current causes an increase in the temperature of the irradiation station and of the solid target material which has to be compensated by the fluid cooling system. In particular, in order not to compromise the operation of the irradiation station, the temperature thereof and that of the solid target material has to be kept within the range comprised between 150 and 200° C. Should the temperature exceed the aforementioned range, the different thermal expansion between the material of the metal support of the container and the solid target material could cause the disjunction of the latter from the metal support with consequent production stop and therefore a drop in the radioisotope production.

### SUMMARY

The object of the present invention is to provide an irradiation station which is exempt from the drawbacks described above and, simultaneously, is easy and cost-effective to manufacture.

In accordance with the present invention, an irradiation station for a radioisotope production system and a radioisotope production system are provided according to what is defined in the appended claims.

### BRIEF DESCRIPTION OF THE DRAWINGS

The present invention will now be described with reference to the accompanying drawings, which illustrate a non-limiting example embodiment thereof, wherein:

FIG. 1 illustrates an exploded axonometric view of a container for a solid target material;

FIG. 2 illustrates the container of FIG. 1 according to a section view along a plane on which the longitudinal axis of the container 1 lies;

FIGS. 3 and 4 illustrate a detail of FIG. 2 during two different uses of the container;

FIG. 5 illustrates, in part and according to a section view, the irradiation station of the present invention for a radioisotope production system which utilizes the container of FIG. 1; and

FIG. 6 illustrates an axonometric view of a part of a cooling system of the irradiation station of FIG. 1.

### DESCRIPTION OF EMBODIMENTS

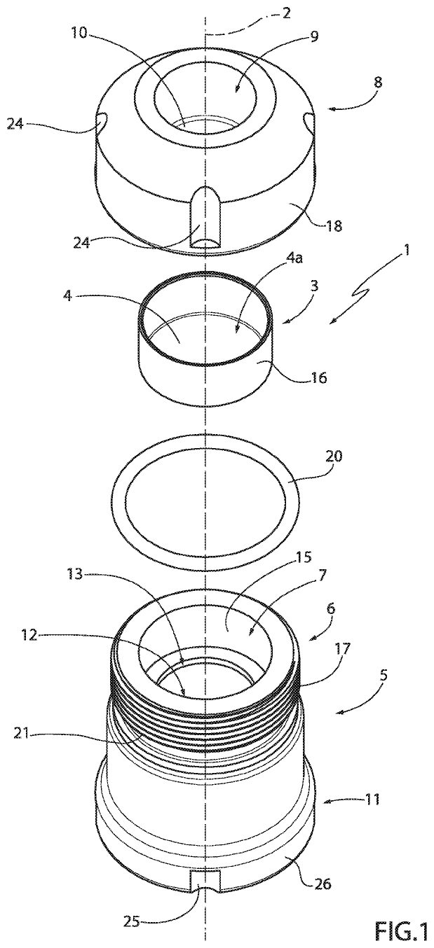

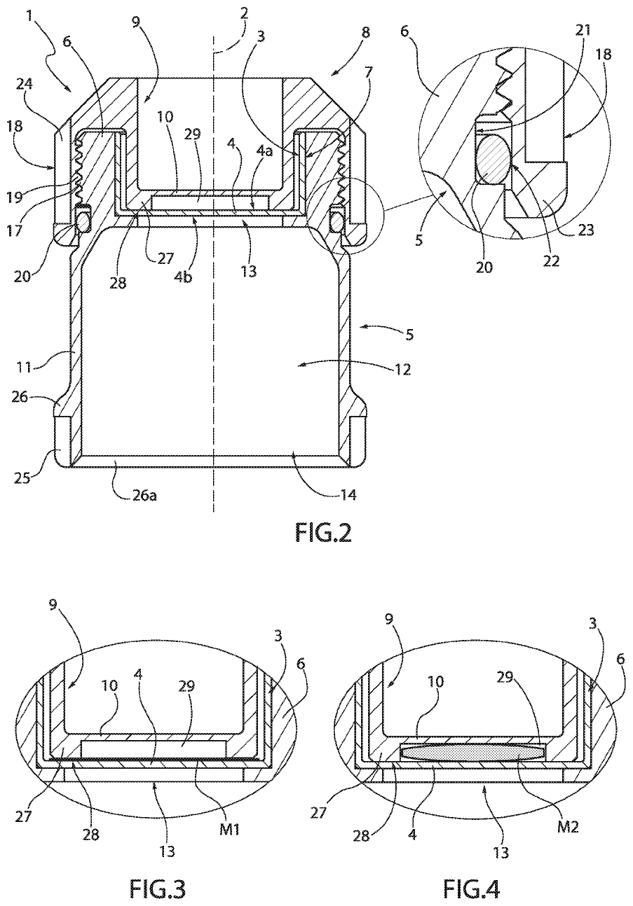

In FIGS. 1 and 2, reference numeral 1 generically indicates, as a whole, the container of the present invention suitable to contain a solid target material and a radioisotope produced by means of irradiation with proton beam of the solid target material.

The container 1 extends according to a longitudinal axis 2 thereof and comprises a well-shaped body 3, in the following simply called well, which is designed to support, on a side 4a of a bottom wall 4 thereof, a portion of solid target material (not illustrated), a support body 5, which extends according to the longitudinal axis 2 and comprises a first portion 6 having a seat 7 designed, in use, to coaxially house the well 3 in such a way that the bottom wall 4 is arranged transverse to the longitudinal axis 2, and a lid 8, which comprises a cup-shaped central portion 9, the bottom of which comprises a degrading foil 10 designed to mitigate the proton beam in a pre-established manner. The lid 8 is designed, in use, to be coaxially fitted on the portion 6 in such a way that the central portion 9 is arranged in the well 3 for holding the portion of solid target material on the bottom wall 4 and that the degrading foil 10 is arranged above, and in particular parallel to, the bottom wall 4 in such a way that the portion of solid target material is arranged, in use, between the degrading foil 10 and the bottom wall 4.

In use, a proton beam (not illustrated in FIGS. 1 and 2) is directed on the central portion 9 in the direction of the longitudinal axis 2, and in particular centred on the longitudinal axis 2, for striking the degrading foil 10 in a substantially perpendicular manner. The degrading foil 10 has a thickness calibrated for mitigating the proton beam in such a measure to transfer to the portion of solid target material arranged in the well 3 a medium energy (MeV) which allows obtaining the desired radioisotope. For example, the thickness of the degrading foil 10 is comprised between 50 μm and 500 μm. The value of the thickness is chosen depending on the radioisotope to be produced. In particular, each radioisotope to be produced is associated with a respective lid 8 having a degrading foil 10 with a specific thickness which is sized depending on the radioisotope.

The support body 5 has a shape of cylindrical symmetry with respect to the longitudinal axis 2. The well 3 has a shape of cylindrical cup, i.e. a cylinder devoid of a base. Also the lid 8 has a shape of cylindrical symmetry.

The support body 5 comprises a second portion 11, which is coaxial to the portion 6. The portion 11 comprises an internal cavity 12, which communicates with the seat 7 through an opening 13 coaxial to the longitudinal axis 2 and with the outside through a further opening 14 (FIG. 2) transverse to the longitudinal axis 2 for allowing the access of a cooling fluid in the cavity 12. As is evident in FIG. 2, the bottom wall 4 of the well 3 closes the opening 13 when the well 3 is in the seat 7 in such a way that a side 4b of the bottom wall 4 opposite the side 4a, in use, is lapped by the cooling fluid. The cavity 12 has a shape of cylindrical symmetry with respect to the longitudinal axis 2 and therefore also the portion 11 has a similar cylindrical shape.

The seat 7 houses the well 3 with hermetic interference between a side internal surface 15 (FIG. 1) of the seat 7 and a side external surface 16 (FIG. 1) of the well 3. Such hermetic interference is obtained with a precise machining of the side internal surface 15 and of the side external surface 16. The side hermetic interference between seat 7 and well 3 prevents, in use, the cooling fluid from passing through the opening 13 and ending up in the well 3. The portion 6 of the support body 5 comprises an external thread 17 and the lid 8 comprises an annular portion 18, which is arranged around, in a coaxial manner, the central portion 9 and comprises an internal thread 19 (FIG. 2) for being screwed to the portion 6.

The container 1 further comprises a hermetic sealing ring 20, which is fitted on the support body 5. In particular, the hermetic sealing ring 20 is held in a groove 21 of the support body 5 arranged between the portion 6 and the portion 11. With particular reference to the enlarged detail of FIG. 2, the hermetic sealing ring 20 enters into contact with the support body 5, and in particular with the groove 21, and an internal surface 22 of an end portion 23 of the annular portion 18 of the lid 8 when the annular portion 18 is screwed to the portion 6. In this manner, the lid 8 hermetically seals the well 3 for preventing radioactive substances from coming out of the well 3 during the production of the radioisotope.

The lid 8 comprises a plurality of external notches 24 and similarly the portion 11 of the support body 5 comprises a plurality of external notches 25 for facilitating the gripping of the fingers of an operator during the closing of the container 1. In particular, the notches 25 are arranged along an end portion 26 of the portion 11 surrounding the opening 14. The end portion 26 is substantially cylindrical with respect to the longitudinal axis 2. The end portion 26 ends with a substantially axial circular edge 26a surrounding the opening 14.

The support body 4 and the lid 8 are made of aluminium, which is an easily workable metal. The well is made of a material suitable to the electrodeposition of the solid target material and is inert to acid substances capable of dissolving the portion of solid target material. Preferably, the well 3 is internally made of platinum. Advantageously, all the walls of the well 3 have a thickness less than 1 mm, in particular approximately 500 μm.

With particular reference to FIG. 2, the central portion 9 comprises an annular rib 27 surrounding the degrading foil 10 and projects from the plane of the degrading foil 10 parallel to the longitudinal axis 2 so as to end with an end surface 28, it too annular, designed to press against the bottom wall 4 of the well 3 when the lid 8 is fitted on the portion 6 so as to define, between the degrading foil 10 and the bottom wall 4, a chamber 29 centred on the longitudinal axis 2 for containing a portion of solid target material. The structure of the central portion 9 allows containing the solid target material in various sizes.

FIG. 3 more specifically illustrates a portion of the container 1 around the chamber 29 in a utilization example in which the portion of solid target material is in the form of metal foil, indicated by M1, which is spread on the bottom of the well 3, i.e. on the bottom wall 4. In use, the lid 8 is fitted on the portion 6 and the annular portion 18 is screwed to the portion 6 until the end surface 28 of the rib 27 presses an edge of the metal foil M1 against the bottom wall 4. The portion of metal foil M1 facing within the chamber 29 will be the one irradiated by the proton beam passing through the degrading foil 10.

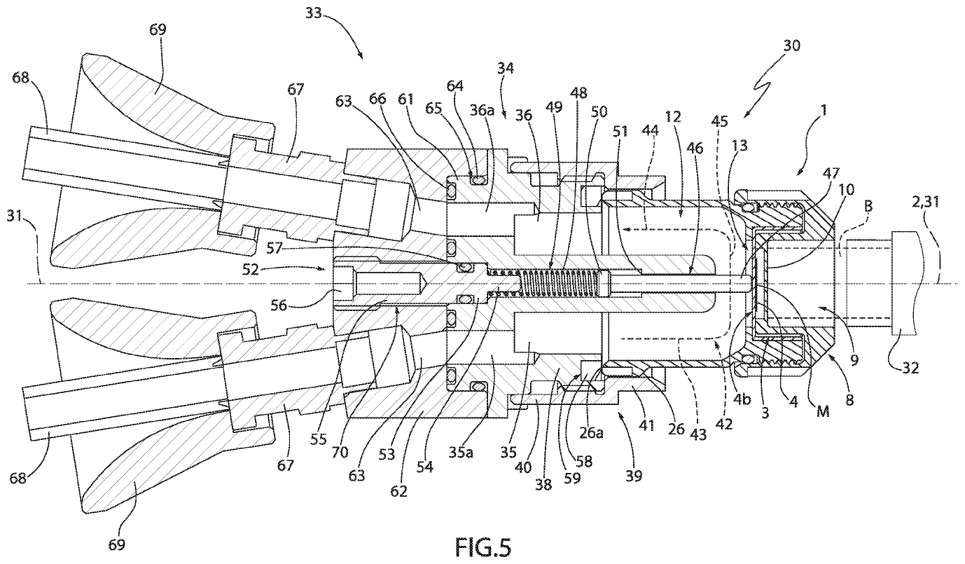

FIG. 4 illustrates the same portion of the container 1 of FIG. 3 in a different utilization example in which the portion of solid target material is in the form of a capsule of compressed powder, indicated by M2, which is housed in the chamber 29. In use, the lid 8 is fitted on the portion 6 and the annular portion 18 is screwed on the portion 6 until the end surface 28 of the rib 27 enters into contact with the bottom wall 4. In this manner, the capsule of compressed power M2 is held by the chamber 29 and in centred position on the longitudinal axis 2. The capsule of compressed powder M2 will thus be completely irradiated by the proton beam through the degrading foil 10.

In a further utilization example not illustrated, the portion of solid target material is in the form of a thin layer of material electrodeposited on the bottom wall 4 of the well 3 so as to remain within the chamber 29, i.e. completely underneath the degrading foil 10 so as to be irradiated by the proton beam which strikes the degrading foil 10.

FIG. 5 illustrates in a simplified manner a part of an irradiation station 30 of a radioisotope production system which comprises the container 1. The radioisotope production system is in general known per se, and thus not specifically illustrated. The container 1 is used in the radioisotope production system for transferring the portion of solid target material between several stations of the system, among which the irradiation station 30. FIG. 5 illustrates the irradiation station 30 according to a section view along a plane on which an alignment axis 31 of the irradiation station 30 lies.

The irradiation station 30 comprises a cyclotron 32 of known type for emitting the proton beam B against the portion of solid target material, for example in the form of a thin layer of electrodeposited material indicated by M, arranged in the container 1. In particular, the cyclotron 32 is of the type capable of emitting a proton beam with energy equal to or above 18 MeV. The proton beam B passes through the degrading foil 10, which offers a pre-established mitigation, and irradiates the portion of solid target material which is in the well 3 laid on the bottom wall 4.

The irradiation station 30 comprises a fluid cooling system 33 connectable to the container 1 for cooling the latter during the irradiation with proton beam B of the solid target material. In particular, the fluid cooling system 33 comprises a connection head 34 designed to couple to the opening 14 of the support body 5 so as to circulate a cooling fluid in the cavity 12.

The container 1 is illustrated in FIG. 5 according to the same section view of FIG. 2. The connection head 34 comprises a delivery conduit 35 and a return conduit 36 for a cooling fluid which face the opening 14 and a flow diverter 37, which is in part arranged between the delivery conduit 35 and the return conduit 36, extends along the axis 31 and is designed to enter the cavity 12 through the opening 14 coaxially to the container 1, i.e. with the axis 31 coinciding with the longitudinal axis 2.

In particular, the connection head 34 comprises a body 38, which is made of aluminium and comprises the flow diverter 37 and in which the delivery conduit 35 and the return conduit 36, and a centring ring nut 39 are obtained, the latter has a first portion 40 screwed to an external threaded portion of the body 38 and a second portion 41 defining a cylindrical seat for the end portion 26 of the container 1. Therefore, the centring ring nut 39 supports the container 1 keeping it centred on the connection head 34, and in particular coaxial to the flow diverter 37.

The centring ring nut 39 also determines the positioning of the container 1 with respect to the cyclotron 32 and thus with respect to the proton beam B. In fact, the cyclotron 32 is aligned with the connection head 34 in such a way that the central portion 9 of the lid 8 is faced towards the cyclotron 32 and the proton beam B is directed on the degrading foil 10 parallel to the longitudinal axis 2, and in particular is centred on the degrading foil 10.

The flow diverter 37 is shaped so as to define in the cavity 12 a circulation path 42 for the cooling fluid. In particular, the circulation path 42 is U-shaped and extends from the delivery conduit 35 to the return conduit 36. More specifically, the circulation path 42 comprises an input section 43 and an output section 44 for the cooling fluid which are parallel to the longitudinal axis 2. The input section 43 communicates with the delivery conduit 35 and the output section 44 communicates with the return conduit 36.

At the opening 13, and in particular parallel to the opening 13, the circulation path 42 comprises an intermediate section 45 transverse to the longitudinal axis 2 in such a way that, in use, the cooling fluid assumes a laminar flow at least along the intermediate section 45. The laminar flow will lap the side 4b of the bottom wall 4 of the well 3 facing from the opening 13.

The flow diverter 37 comprises a hole 46 centred on the axis 31 and the connection head 34 comprises a tip 47, which protrudes, in part, from the hole 46 and is movable along the hole 46 against the action of a spring 48. The spring is housed in the body 38 so as to be centred on the axis 31 and is in electrical contact with the tip 47. Preferably, the spring 48 is a helical spring. In particular, the flow diverter 37 comprises a further hole 49, which is coaxial with the hole 46 and communicates with the hole 46 for housing the spring 48.

Preferably, the hole 49 has a greater diameter than the hole 46 and the tip 47 has an enlarged end 50, which slides in the hole 49 and is in contact with a first end of the spring 48. In the absence of the container 1, i.e. in a configuration not illustrated in the figures, the enlarged end 50, thanks to the thrust of the spring 48, abuts against a shoulder 51 defined by the different diameters of the holes 46 and 49 in such a way that the tip 47 protrudes from the hole 46 with a maximum extension.

When the connection head 34 is coupled to the opening 14, as is illustrated in FIG. 5, the tip 48 passes through the opening 13 and presses against the side 4b of the bottom wall 4 of the well 3, partially re-entering the hole 46. The spring 48 compresses and keeps the tip 47 pressed against the side 4b of the bottom wall 4 thus creating an electrical contact between the tip 47 and the bottom wall 4.

The connection head 34 comprises an electrical connector 52 which is in electrical contact with the spring 48, in particular with the second end of the spring 48. Specifically, the electrical connector 52 comprises a first portion 53, which hydraulically seals an end of the hole 49 and has a pin 54 jutting in the hole 49 and engaging with contact the second end of the spring 48, and a second portion 55, which comprises an electrical socket 56 of the jack type accessible from the outside. An O-ring 57 fitted on the portion 53 ensures the hydraulic sealing between the portion 53 and an enlarged portion of the hole 49.

A current meter (not illustrated), which is optionally part of the irradiation station 30, is connectable to the electrical connector 52, and in particular to the electrical socket 56 by means of a plug of the jack type, for measuring an electric current in the portion of solid target material M which is induced by the proton beam B and which is thus an indirect indication of the beam current set on the cyclotron 32.

Preferably, the tip 47 is made of copper for reducing the electric resistance thereof and is gold-plated for improving the electrical contact with the bottom wall 4 of the well 3 of the container 1. Preferably, the spring 48 is made of stainless steel and is gold-plated for improving the electrical contact with the tip 47 and with the pin 54. Preferably, the electrical connector 52 is made of copper for reducing the electric resistance thereof and is gold-plated for improving the electrical contact with the spring 48.

The connection head 34 comprises an annular seal 58, which is arranged in an axial annular seat 59 of the body 38 and has a flat face suitable for sealing the edge 26a of the end portion 26 of the container 1.

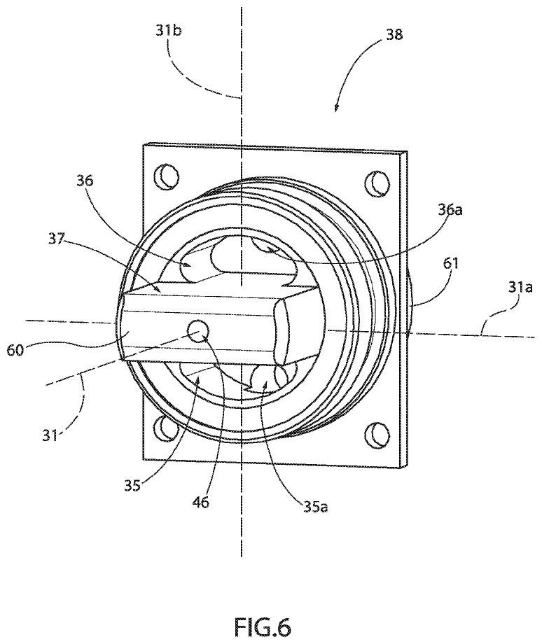

With reference also to FIG. 6, which illustrates the body 38 according to a front axonometric view, the flow diverter 37 has a transverse dimension which is predominant along a direction 31a orthogonal to the axis 31 and the 36 a delivery conduit 35 and the return conduit have transverse section which is flattened along a direction 31b orthogonal to the axis 31 and to the direction 31a for favouring, in use, i.e. inside the cavity 12 of the container 1, the formation of the laminar flow at a top 60 of the flow diverter 37. The hole 46 from which the tip 47 protrudes opens at the top 60. The delivery conduit 35 and the return conduit 36 extend inside the body 38 in the form of respective fitting holes 35a and 36a, which open at a rear portion 61 of the body 38 and are preferably parallel to the axis 31.

Still with reference to FIG. 5, the connection head 34 comprises a further body 62, which is made of PEEK, i.e. polyether ether ketone, comprises two through holes 63, and is hydraulically coupled to the body 38 in such a way that a first one of the through holes 63 communicates with the delivery conduit 35, in particular through the fitting hole 35a, and the second one of the through holes 63 communicates with the return conduit 36, in particular through the fitting hole 36a.

PEEK is a material that insulates from the electric currents. In such manner, the connection head 34 with the body 62 made of PEEK allows electrically insulating a part of the cooling system 33 from the cyclotron 32.

The hydraulic sealing between the body 38 and the body 62 is ensured by three O-rings. In particular, one O-ring 64 is fitted on the rear portion 61 and the latter engages a radial seat 65 of the body 62. Furthermore, two further O-rings 66 are arranged in respective seats of a face of the rear portion 61 transverse to the axis 31 for each ensuring the hydraulic sealing between a respective through hole 63 and a respective fitting hole 35a, 36a.

Each through hole 63 is provided with a respective fitting 67 to which a respective pipe 68 is connected in which the cooling fluid circulates. Each fitting 67 is, in turn, provided with a respective adjuster 69 for the pipe 68.

The body 62 has a further through hole 70 passed through by the portion 55 of the electrical connector 52.

An advantage of the irradiation station 30 described above is a better cooling of the well 3 and thus of the portion of solid target material during the irradiation step of the latter, thanks to the laminar flow of the cooling fluid which laps the side 4b of the bottom wall 4 through the opening 13 of the internal cavity 12 of the support body 5. In particular, the flow diverter 37 entering the cavity 12 for defining therein a U-shaped circulation path 36, allows the cooling fluid to assume, at the opening 13, and in particular in the intermediate section 45 of the circulation path 42, a laminar flow which laps the side 4b of the bottom wall 4.

Another advantage of the irradiation station 30 is the possibility to measure the current circulating in the solid target material while it is irradiated by the proton beam, thanks to the presence of the tip 47 protruding from the hole 46 at the top 60 of the flow diverter 37 and which enters into contact with the side 4b of the bottom wall 4 of the well 3 by effect of the thrust of the spring 48. Furthermore, the tapered shape of the tip 47 does not bother the laminar flow of the cooling fluid which is formed in the intermediate section 45 of the circulation path 42, i.e. between the top 60 of the flow diverter 37 and the bottom wall 4.

1. An irradiation station for a radioisotope production system, the irradiation station (30) comprising a cyclotron (32) for emitting a proton beam (B) against a portion of solid target material (M) contained in a container (1) and a cooling system (33) for cooling the container (1) during the irradiation of the portion of solid target material (M); the container (1) extending along a first axis (2) and comprising a support wall (4) for supporting, on a first side (4a), the portion of solid target material (M) and an internal cavity (12), which borders the support wall (4), on a second side (4b) opposite the first side (4a), and communicates with the outside through a first opening (14) transverse to the first axis (2); the cooling system (33) comprising a connection head (34) and the latter comprises: a delivery conduit (35) and a return conduit (36) for a cooling fluid; a flow diverter (37) extending along a second axis (31); a tip (47), which protrudes, in part, from a hole (46) of the flow diverter (37) and is movable along said hole (46) against the action of a spring (48) housed in the connection head (34) and in electrical contact with the tip (47), said hole (46) being centred on the second axis (31); and an electrical connector (52) in electrical contact with the spring (48); the connection head (34) being designed to couple to the first opening (14) for circulating the cooling fluid in the cavity (12) and in such a way that the flow diverter (37) enters the cavity (12) coaxially with the container (1) and the tip (47) presses against said second side (4b).

2. The irradiation station according to claim 1, and comprising a current meter connected to the electrical connector (52) for measuring an electric current in the portion of solid target material (M) induced by the proton beam (B).

3. The irradiation station according to claim 1, wherein said flow diverter (37) is shaped to define in the cavity (12) a U-shaped circulation path (42) for the cooling fluid extending from the delivery conduit (35) to the return conduit (36).

4. The irradiation station according to claim 3, wherein said circulation path (42) comprises an intermediate section (45) transverse to the first axis (2) so that, in use, the cooling fluid assumes a laminar flow at least along the intermediate section (45).

5. The irradiation station according to claim 1, wherein said spring (48) is helical, is arranged in a housing (49) of the connection head (34) and has a first end in contact with a portion (50) of the tip (47) which is movable within the housing (49); said electrical connector (52) comprising a pin (54), which engages with contact a second end of the spring (48), and an electrical socket (56) of the jack type accessible from the outside.

6. The irradiation station according to claim 1, wherein said container (1) comprises a cylindrical portion (26) ending with an edge (26a) surrounding the first opening (14) and said connection head (34) comprises a first body (38), which is made of aluminium and comprises said flow diverter (37), delivery conduit (35) and return conduit (36), and an annular seal (58), which is arranged in an annular seat (59) of the first body (38) and has a flat face suitable for sealing said edge (26a).

7. The irradiation station according to claim 1, wherein said connection head (34) comprises a first body (38), which is made of aluminium and comprises said flow diverter (37), delivery conduit (35) and return conduit (36), and a second body (62), which is made of PEEK, comprises two through-holes (63), each provided with a respective fitting (67) for a respective pipe (68) for the cooling fluid, and is hydraulically coupled to the first body (38) in such a way that a first through-hole (63) communicates with the delivery conduit (35) and the second through-hole (63) communicates with the return conduit (36).

8. The irradiation station according to claim 1, wherein said container (1) comprises a cylindrical portion (26) surrounding the first opening (14) and said connection head (34) comprises a first body (38), which is made of aluminium and comprises said flow diverter (37), delivery conduit (35) and return conduit (36), and a centring ring nut (39), which has a first portion (40) screwed to the outside of the first body (38) and a second portion (41) defining a cylindrical seat for the cylindrical portion (26) of the container (1).

9. A radioisotope production system comprising a container (1) for containing a portion of solid target material (M) and an irradiation station (30); the container (1) extending along a first axis (2) and comprising a support wall (4) for supporting, on a first side (4a), the portion of solid target material (M) and an internal cavity (12), which borders the support wall (4), on a second side (4b) opposite the first side (4a), and communicates with the outside through a first opening (14) transverse to the first axis (2); the irradiation station (30) being according to claim 1.

10. A radioisotope production system according to claim 9, wherein said container (1) comprises a well (3), which has a bottom wall coinciding with said support wall (4), and a support body (5) comprising a first portion (6), which has a seat (7) for housing the well (3), and a second portion (11), which has said internal cavity (12) and communicates with the seat (7) through a second opening (13) transverse to said first axis (2) in such a way that, in use, when said connection head (34) is coupled to said first opening (14), the tip (47) passes through said second opening (13).
